(19) United States
(12) Patent Application Publication
(10) Pub. No.: US 2021/0101266 A1
(43) Pub. Date: Apr. 8, 2021

(54) Tool Kit for Bicycle

(71) Applicant: Cyclingdeal USA Inc., Ponoma, CA (US)

(72) Inventor: Haidong Gu, Pomona, CA (US)

(21) Appl. No.: 16/591,324

(22) Filed: Oct. 2, 2019

(51) Int. Cl. B25B 27/00; B25F 1/02

(52) U.S. Cl. CPC B25B 27/0071; B25B 13/46; B25F 1/02

(57) ABSTRACT

A tool kit includes a case, a first tool device, and a second tool device. The case has a main member, a first cover, and a second cover. The main member has a first end and a second end opposite to the first end. The first cover is detachably connected to the first end of the main member while the second cover is detachably connected to the second end of the main member. The case has a first chamber and a second chamber, and the first chamber is isolated from the second chamber. The first cover is separated from the main member to expose the first chamber, and the second cover is separated from the main member to expose the second chamber. The first tool device is received in the first chamber of the case, and the second tool device is received in the second chamber of the case.

### BACKGROUND OF THE INVENTION

### 1. Technical Field

The present invention relates generally to an accessory of a bicycle, and more particularly to a tool kit for bicycle.

### 2. Description of Related Art

In early days, bicycles are one type of the vehicles for transportation. However, more and more people ride bicycle for exercise and casual activity. Typically, a conventional bicycle includes a frame, a front and a rear wheels connected to the frame, a handlebar connected to a fork which is connected to the front wheel to be held by a cyclist to control a moving direction of the bicycle, and a transmission assembly, including a pair of pedals, a crank arm, a chain ring, a chain, and a cogset, to be powered by the cyclist to make the bicycle to move.

The last thing the cyclists want to meet is the bicycle malfunctioned on the road. The commonest problem of the bicycles is flat tire. The bicycle with flat tire cannot be ridden anymore unless you want to break the rim. When you have a flat tire the only thing you can do it move your bicycle off the road and get help unless you have tools to fix the flat tire. However, there is no suitable tool kit to be carried by the cyclist.

### BRIEF SUMMARY OF THE INVENTION

In view of the above, the primary objective of the present invention is to provide a tool kit for bicycle to be carried by a cyclist.

In order to achieve the objective of the present invention, a tool kit, includes a case, which has a main member, a first cover, and a second cover, wherein the main member has a first end and a second end opposite to the first end. The first cover is detachably connected to the first end of the main member while the second cover is detachably connected to the second end of the main member. The case has a first chamber and a second chamber, and the first chamber is isolated from the second chamber. The first cover is separated from the main member to expose the first chamber, and the second cover is separated from the main member to expose the second chamber. A first tool device is received in the first chamber of the case. A second tool device is received in the second chamber of the case.

In an embodiment, the main member has the first chamber therein, and the second cover has the second chamber therein.

In an embodiment, the first end of the main member is an open end to be an entrance of the first chamber, and the second end of the main member is a closed end to be connected to an open end of the second cover; the open end of the second cover is an entrance of the second chamber.

In an embodiment, the second tool device is connected to the main member, whereby the main member becomes a handle of the second tool device when the second cover is removed from the main member.

In an embodiment, the first tool device includes a base, a wrench, and a plurality of bits; the wrench and the bits are detachably connected to the base.

In an embodiment, the wrench has a recess, and the base has a post to be inserted into the recess of the base.

In an embodiment, a magnet is mounted in the recess of the wrench, and the post is made of a material which is attracted by the magnet.

In an embodiment, each of the bits is able to be inserted into the recess of the wrench to be attracted by the magnet.

In an embodiment, the base is provided with a plurality of slots, in each of which one of the bits is received.

The present invention provides the tool kit for bicycle, which has different kinds of the tool devices and may help the cyclist to fix his/her bicycle. The tool kit is easy to be carried by the cyclist or fastened on the bicycle.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is an exploded view of the preferred embodiment of the present invention;

FIG. 3 is a sectional view of the preferred embodiment of the present invention; and

FIG. 4 is a perspective view of the first tool device of the preferred embodiment of the present invention.

### DETAILED DESCRIPTION OF THE INVENTION

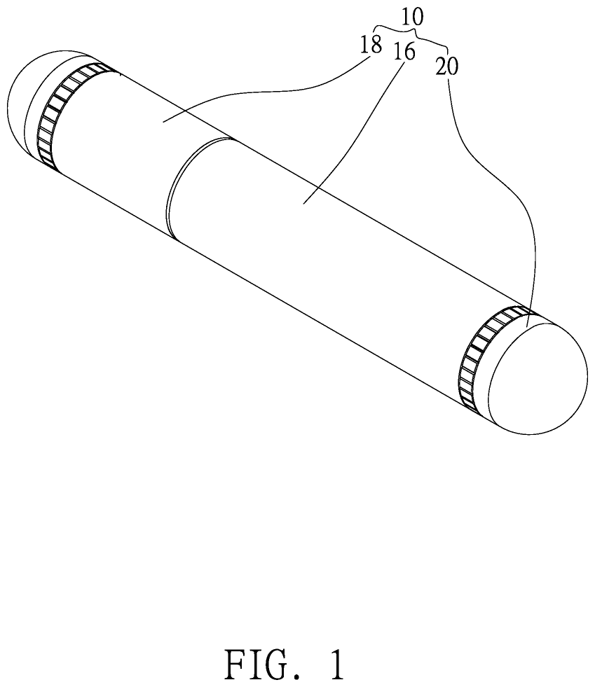

As shown in FIG. 1, a tool kit of the preferred embodiment of the present invention includes a case 10, a first tool device 12, and a second tool device 14.

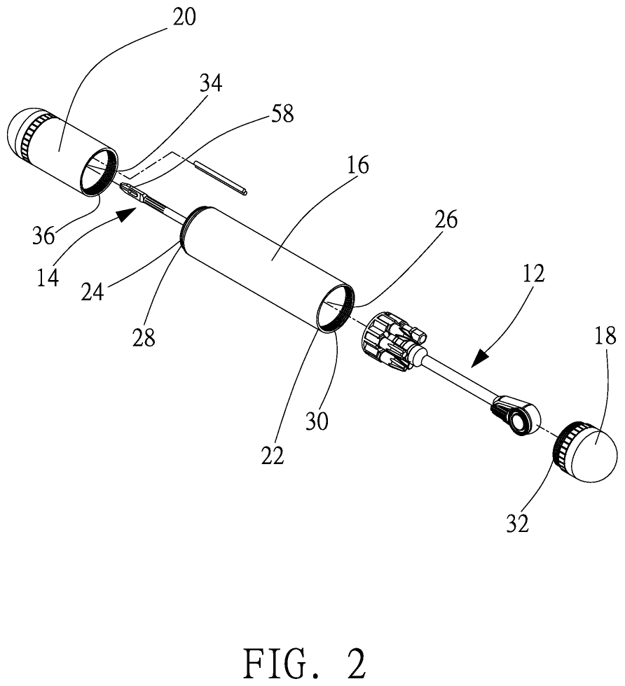

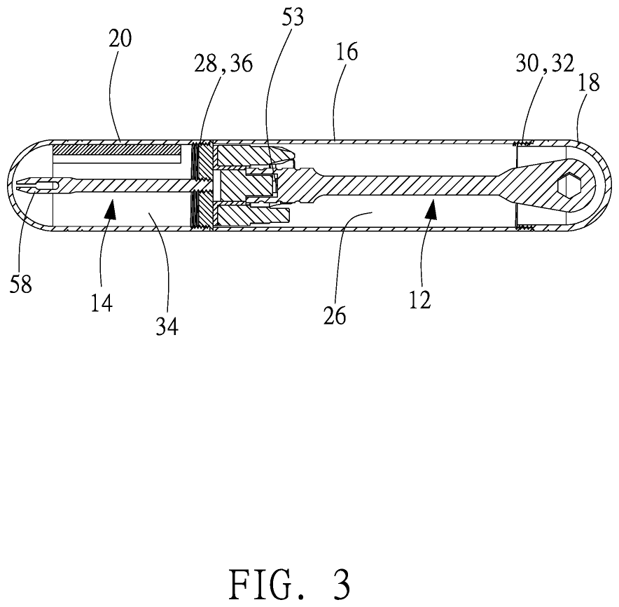

As shown in FIGS. 2 and 3, the case 10 has a main member 16, a first cover 18, and a second cover 20. The main member 16 is a tubular member having a first end 22 and a second end 24. The first end 22 is an open end, and the second end 24 is a closed end. The main member 16 has a first chamber 26 therein, and the first end 22 is an entrance of the first chamber 26. An outer threaded section 28 is provided on an outer side of the main member 16 adjacent to the second end 24, and an inner threaded section 30 on a sidewall of the first chamber 26 adjacent to the first end 22. The first cover 18 has an outer threaded section 32 to be meshed with the inner threaded section 30 of the main member 16, whereby the first cover 18 is connected to the first end 22 of the main member 16 and close the first chamber 26. The second cover 20 is a barrel-like member, having a second chamber 34 therein. The second cover 20 has an inner section 36 on a sidewall of the second chamber 34 adjacent to an open end of the chamber to be meshed with the outer threaded section 28 of the main member 16, whereby the second cover 20 is connected to the second end 24 of the main member 16 and close the second chamber 34.

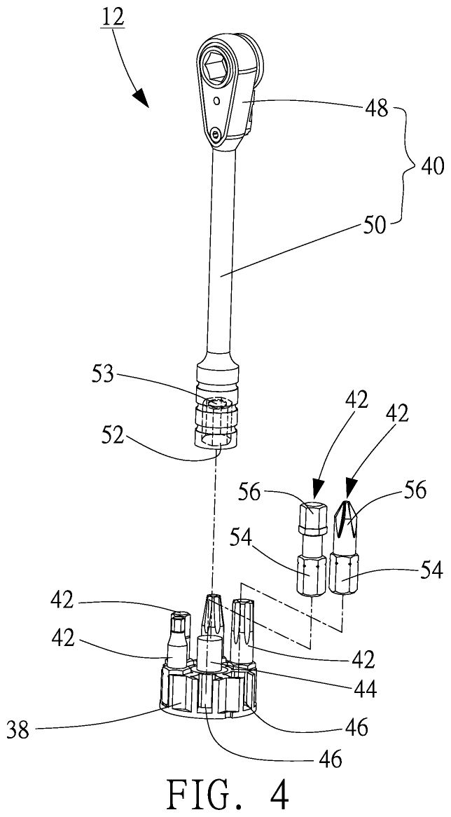

The first tool device 12 is received in the first chamber 26 of the case 10. As shown in FIG. 4, the first tool device 12 includes a base 38, a wrench 40, and six bits 42 in the present preferred embodiment. The base 38 had a post 44 at a center and six slots 46 around the post 44. The post 44 is made of iron, which is attracted by magnet. The wrench 40 is a reversible ratchet wrench, having a driving head 48 and a handle 50. The driving head 48 is connected to an end of the handle 50, and the handle 50 is provided with a recess 52 on an end opposite to the driving head 48. A magnet 53 is mounted in the recess 52. Each of the bits 42 has a connecting portion 54 and a driving portion 56. The connecting portions 54 of the bits 42 are the same to be detachably connected to the driving head 48 of the wrench 40, and the driving portions 56 are different for working for different purposes. The wrench 40 is connected to the base 38 with an engagement of the recess 52 and the post 44. The magnet 53 attracts the post 44 to firmly connect the wrench 40 to the base 38. The bits 42 are connected to the base 38 by inserting the connecting portions 54 of the bits 42 into the slots 46 in interference fit respectively. User may fit the bit 42 into the recess 52 of the wrench 40 to make the magnet 53 attract the bit 42, which is helpful to removal of the bit 42 from the slot 46 of the base 38.

The second tool device 14 is received in the second chamber 34 of the case 10. In the present preferred embodiment, the second tool device 14 includes a needle tool 58 which is used to insert a plug into a hole of a tubeless tire (no shown) for repairing punctures in the tubeless tire. The needle tool 58 has an end connected to the second end 24 of the main member 16 of the case 10. As a result, when the second cover 20 is removed to expose the needle tool 58, the main member 16 becomes a handle of the needle tool 58 to be held by user.

There still are spaces in the first and the second chambers 26, 34 when the first and the second tool device are received therein, and some accessories or tools may be stored in the first and the second chambers 26, 34. In the present preferred embodiment, plugs, which are used to be inserted into a hole of a tubeless tire for repairing punctures in the tubeless tire, are received in the second chamber 34.

In conclusion, the tool kit of the present invention provides different kinds of the tool devices to be received in the chambers of the case, which may help the cyclist to fix his/her bicycle. In addition, the bar-like case is easy to be carried by the cyclist or fastened on the bicycle.

It must be pointed out that the embodiments described above are only some preferred embodiments of the present invention. All equivalent structures which employ the concepts disclosed in this specification and the appended claims should fall within the scope of the present invention.

What is claimed is:

1. A tool kit, comprising:
a case having a main member, a first cover, and a second cover, wherein the main member has a first end and a second end opposite to the first end; the first cover is detachably connected to the first end of the main member while the second cover is detachably connected to the second end of the main member; the case has a first chamber and a second chamber, and the first chamber is isolated from the second chamber; the first cover is separated from the main member to expose the first chamber, and the second cover is separated from the main member to expose the second chamber;
a first tool device received in the first chamber of the case; and
a second tool device received in the second chamber of the case.

2. The tool kit of claim 1, wherein the main member has the first chamber therein, and the second cover has the second chamber therein.

3. The tool kit of claim 2, wherein the first end of the main member is an open end to be an entrance of the first chamber, and the second end of the main member is a closed end to be connected to an open end of the second cover; the open end of the second cover is an entrance of the second chamber.

4. The tool kit of claim 1, wherein the second tool device is connected to the main member, whereby the main member becomes a handle of the second tool device when the second cover is removed from the main member.

5. The tool kit of claim 1, wherein the first tool device includes a base, a wrench, and a plurality of bits; the wrench and the bits are detachably connected to the base.

6. The tool kit of claim 5, wherein the wrench has a recess, and the base has a post to be inserted into the recess of the base.

7. The tool kit of claim 6, wherein a magnet is mounted in the recess of the wrench, and the post is made of a material which is attracted by the magnet.

8. The tool kit of claim 7, wherein each of the bits is able to be inserted into the recess of the wrench to be attracted by the magnet.

9. The tool kit of claim 5, wherein the base is provided with a plurality of slots, in each of which one of the bits is received.
